(19) United States
(12) Patent Application Publication
(10) Pub. No.: US 2009/0134139 A1
(43) Pub. Date: May 28, 2009

(54) Versatile Bath and Cleansing Water Dispenser and Methods of Production

(76) Inventor: Stephanie Quartararo, Studio City, CA (US)

Correspondence Address: BUCHALTER NEMER, 18400 VON KARMAN AVE., SUITE 800, IRVINE, CA, 92612, US

(21) Appl. No.: 12/324,195

(22) Filed: Nov. 26, 2008

Related U.S. Application Data
(60) Provisional application No. 60/990,577, filed on Nov. 27, 2007.

(51) Int. Cl. H05B 3/00; B67D 5/62

(52) U.S. Cl. 219/214; 222/146.5

(57) ABSTRACT

A bathing and cleansing device is described that includes a heating mechanism; a liquid reservoir coupled to the heating mechanism, and a dispensing mechanism coupled to the liquid reservoir.

This application is a United States Utility Application that is based on U.S. Provisional Application Ser. No.: 60/990577 filed on Nov. 27, 2007, which is commonly-owned and incorporated herein in its entirety.

### FIELD OF THE SUBJECT MATTER

The field of the subject matter is a versatile bath and cleansing water dispenser, along with methods of production of the contemplated dispensers.

### BACKGROUND

Parents, hospitals and child-care workers have been looking for safe and healthy methods and devices to clean babies, children and their surrounding spaces. One of the most widely used methods to clean babies and children is the bath, which generally takes place in a conventional bathtub or a smaller movable bath container. For more targeted bathing tasks—a treated baby wipe can be used.

Cleaning surrounding spaces has become a more complicated task, because of germs, bacteria, dirt and other materials, such as allergens. The latest solution to this problem has been to introduce bleach and other chemicals to cleaning solutions. Although chemicals are generally effective at cleaning spaces, it is becoming clear that these chemicals can cause short-term and long-term health problems, including allergies, headaches and skin rashes.

In both instances of bathing babies and children and cleaning surrounding spaces, it is clear that there is a need for those devices and methods to be portable, versatile and as safe as possible. It would also be ideal for these devices and methods to be consolidated into one all-purpose device. There are devices currently used to heat water to boiling or slightly lower than boiling, such as electric tea kettles or hot pot devices; however, these devices are not designed to or capable of holding water at temperatures significantly below boiling. Fortunately and surprisingly, a device, which is described herein, has been developed that meets all of these needs and goals.

### SUMMARY OF THE SUBJECT MATTER

A bathing and cleansing device is described that includes a heating mechanism; a liquid reservoir coupled to the heating mechanism, and a dispensing mechanism coupled to the liquid reservoir.

### BRIEF DESCRIPTION OF THE FIGURES

FIG. 1 shows a contemplated bathing and cleansing device located on top of a baby's cabinet.

FIG. 2 shows a perspective view of a contemplated bathing and cleansing device.

FIG. 3 shows a side perspective of a contemplated bathing and cleansing device.

FIG. 4 shows a touch pad control device on a contemplated bathing and cleansing device.

FIG. 5 shows a reservoir indicator device on a contemplated bathing and cleansing device.

FIG. 6 shows a dispenser device on a contemplating bathing and cleansing device, wherein a liquid is being dispensed onto a cloth for use.

FIG. 7 shows a contemplated bathing and cleansing device with an integrated spill tray.

FIG. 8 shows a perspective view of a contemplated bathing and cleansing device with an integrated spill tray.

### DETAILED DESCRIPTION

Surprisingly, a comprehensive portable device that is versatile and safe for bathing babies and children, along with cleaning surrounding areas has been developed. Contemplated devices heat and hold water temperatures at significantly lower than boiling temperature, so as to be safe for infants and children.

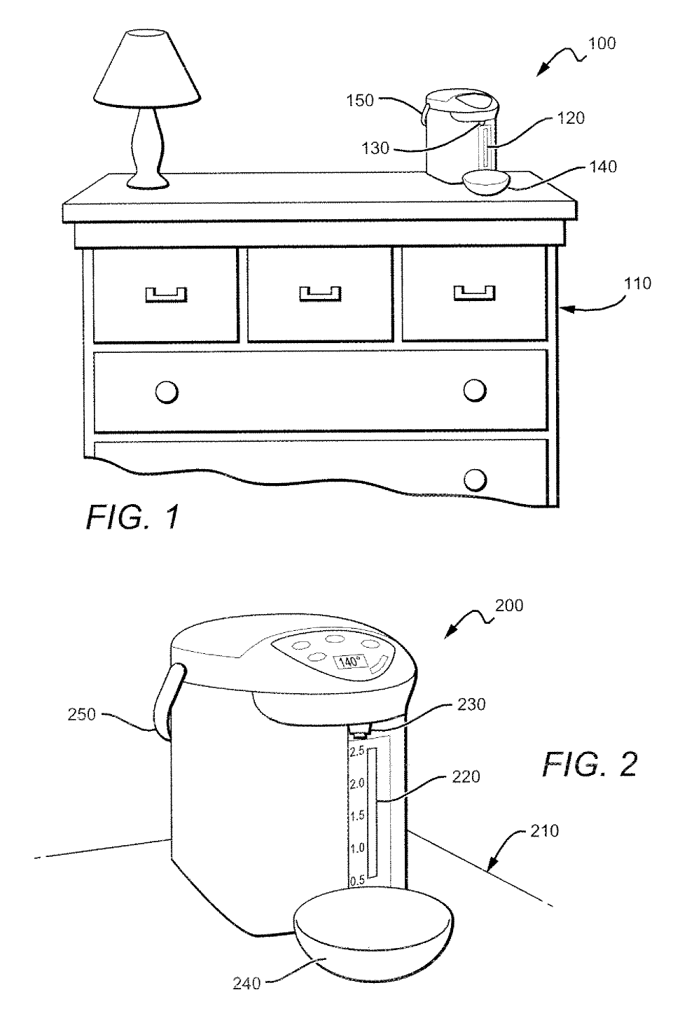

Contemplated versatile bathing devices are shown in FIGS. 1 through 8, which will be described in detail herein, and include a device having a reservoir and heating mechanism, whereby water is stored and heated to a predetermined temperature for dispensing and use for both bathing babies and children on-site, but also cleaning the surrounding spaces.

Contemplated heating mechanisms comprise a suitable heating element, wherein the heating element may comprise an independent heating element, along with a heating element for the reservoirs. In some embodiments, the independent heating reservoir may comprise a heated contact area for receiving a dish, a plate or a cloth receptacle.

Contemplated devices may comprise a power element and be powered by electricity, battery power, solar power or a combination thereof.

FIG. 1 shows a contemplated bathing and cleansing device 100 located on top of a baby's cabinet 110. A contemplated bathing and cleansing device is described that includes a heating mechanism (not shown); a liquid reservoir 120 coupled to the heating mechanism, and a dispensing mechanism 130 coupled to the liquid reservoir 120. This contemplated embodiment also comprises a handle 150. In front of the bathing and cleansing device 100 is a bowl 140 utilized as a spill tray. FIG. 1 shows how compact these contemplated devices can be in a baby's or children's room.

FIG. 2 shows a closer perspective view of a contemplated bathing and cleansing device 200 located on top of a baby's cabinet 210. A contemplated bathing and cleansing device is described that includes a heating mechanism (not shown); a liquid reservoir 220 coupled to the heating mechanism, and a dispensing mechanism 230 coupled to the liquid reservoir 220. This contemplated embodiment also comprises a handle 250. In front of the bathing and cleansing device 200 is a bowl 240 utilized as a spill tray.

The reservoir for contemplated devices is designed to hold a suitable amount of water or another suitable liquid, such that the device can remain portable, while at the same time not needing to be filled up every day or week. In some contemplated embodiments, the reservoir can hold up to five liters of liquid, such as water. In other embodiments, the reservoir can hold up to three liters of liquid, such as water. In yet other embodiments, the reservoir can hold up to one liter of water. Also, contemplated reservoirs are designed to hold tap water, bottled water, distilled water or saline solution, if needed. In some embodiments, the reservoir in the device reboils the water and descales itself, so that its not necessary to use distilled water unless desired.

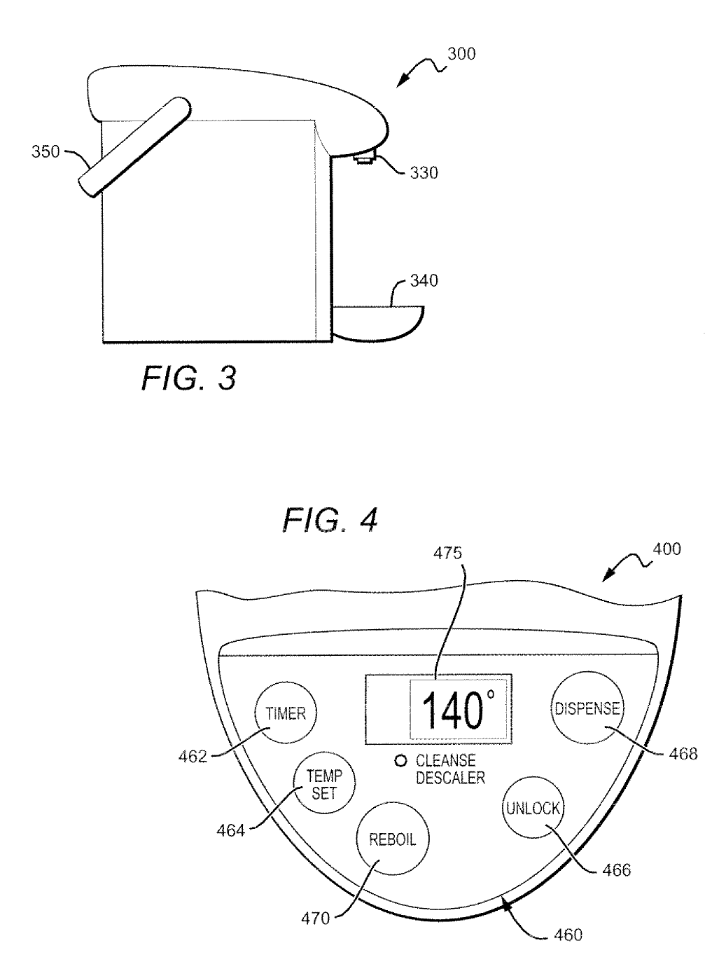

FIG. 3 shows a side perspective of a contemplated bathing and cleansing device 300. In this view, the dispensing mechanism 330 is shown, along with the handle 350. The bowl 340 that is utilized for the spill tray is also shown.

Contemplated devices designed to dispense suitable liquids at a pre-set temperature into a separate or integrated bowl or dish to be used with a washcloth or directly onto a washcloth. The heated liquid or water can then be used to clean the skin or to clean surrounding areas depending on the temperature of the water. Therefore, contemplated devices may have at least one temperature setting. In some embodiments, contemplated devices have more than one temperature setting, wherein the settings are designed to be in a range from slightly lower than body temperature (98° F.) to an appropriate temperature to clean surfaces, such as around 120° F. The temperature settings are clearly marked and/or indicated on contemplated devices, primarily for safety reasons. The temperature of the liquid or liquids in contemplated devices is controlled by any suitable internal temperature device, as mentioned earlier.

In some embodiments, the predetermined temperature comprises a temperature less than the boiling temperature of the liquid. In other embodiments, the predetermined temperature comprises a temperature that is at least 10 percent lower than the boiling temperature of the liquid. In yet other embodiments, the predetermined temperature comprises a temperature that is at least 25 percent lower than the boiling temperature of the liquid. In some contemplated embodiments, the predetermined temperature comprises a sanitizing temperature, meaning that the temperature of the liquid can—at least in part—sanitize a surface, cloth or other item.

Contemplated bathing and cleansing devices may comprise at least one control device to control the operation and use of the bathing and cleansing device. In some embodiments, the at least one control device may comprise at least one touch pad, at least one switch, at least one knob or a combination thereof. The control device may comprise digital circuitry, analog circuitry or a combination thereof.

A suitable dispenser is coupled with the reservoir in order to move water from the reservoir to the outside of the device. These dispensers may comprise any collection of tubing, pipes, and recesses. In addition, these dispensers may be constructed out of any suitable material, such as metals or high performance plastics and composites.

FIG. 4 shows a touch pad control device 460 on the top of a contemplated bathing and cleansing device 400. Several controls are shown on this particular control device 460, such as the timer 462, the temperature control 464, the unlock button 466, the dispense button 468 and the reboil button 470 utilized to reheat the water. A temperature indicator 475 is also shown on the control device 460.

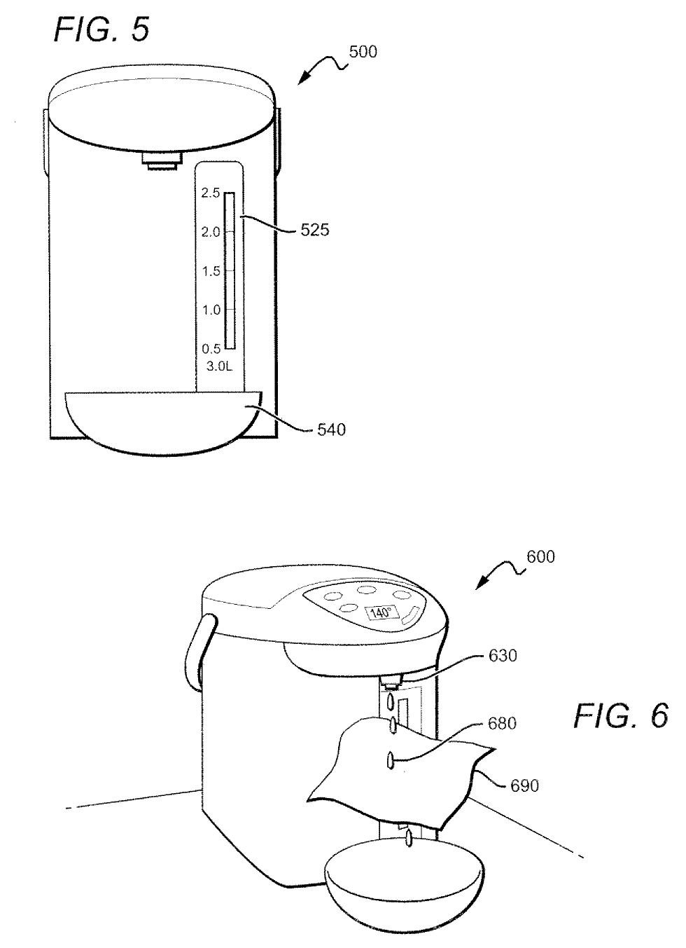

FIG. 5 shows a reservoir indicator device 525 on a contemplated bathing and cleansing device 500. This particular reservoir indicator device 525 shows that the cleansing device 500 holds three (3) liters of liquid, such as water. The bowl 540 that is utilized for the spill tray is also shown.

FIG. 6 shows a dispensing mechanism 630 on a contemplating bathing and cleansing device 600, wherein a liquid 680 is being dispensed onto a cloth 690 for use. The bowl 640 that is utilized for the spill tray is also shown.

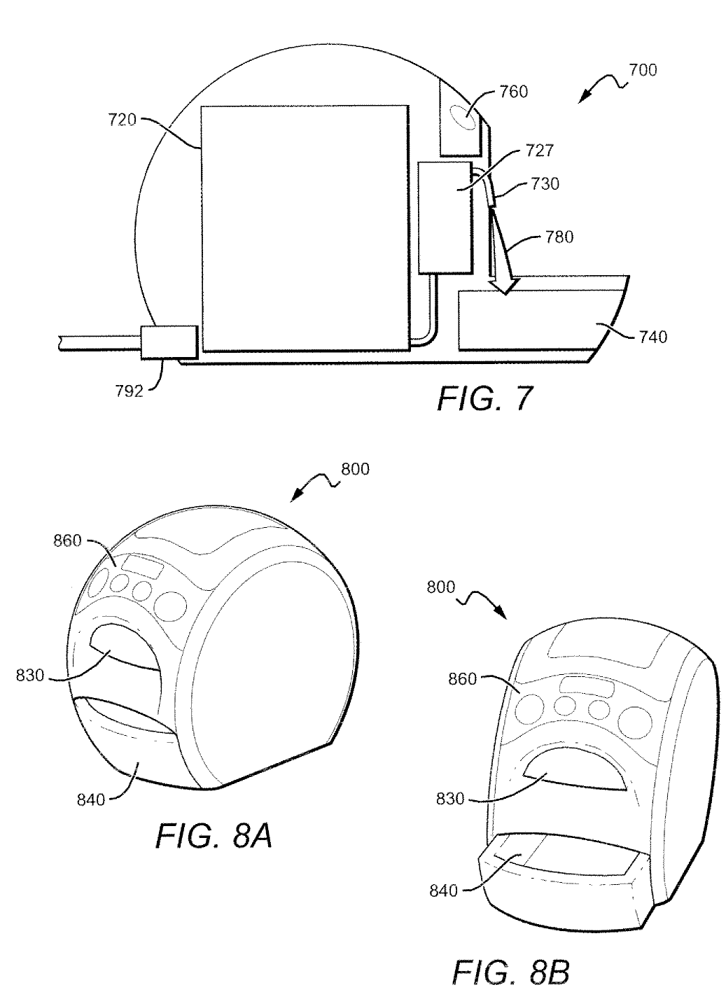

In another contemplated embodiment, as shown in FIG. 7, a contemplated bathing and cleansing device 700 comprises an integrated spill tray 740. In this embodiment, a pump 727 is coupled to the reservoir 720 and the dispensing mechanism 730 that is designed to direct liquid 780 from the reservoir 720 to the dispensing mechanism 730. This embodiment also shows a power plug 792 and a control panel 760. In some embodiments, the reservoir may be directly coupled to the dispensing mechanism without the use of a pump. FIGS. 8A and 8B show perspective views of a contemplated bathing and cleansing device 800 with an integrated spill tray 840. In this embodiment, a dispensing mechanism 830 is shown. This embodiment also shows a control panel 860.

A contemplated safety feature of the bathing devices disclosed herein is that the device can lock or be secured in such a manner so that babies and children cannot open the device or get burned if it leans or tips over during use. These safety features are key to the device, because contemplated devices are designed to sit on a changing table, a dresser, a table top or other low surface. They are designed to be in use most, if not all, of the time, primarily so that users can have hot water at their disposal when they need it most. In some embodiments, contemplated safety features will take the form of a locking mechanism, wherein the locking mechanism is coupled to the heating element, the dispenser or a combination thereof. Another safety feature found in some contemplated embodiments is that the device will not power up or operate unless the integrated spill tray is engaged and pulled out, as shown in FIG. 8B.

In some embodiments, contemplated devices comprise a holder or dispenser for dispensing or containing disposable cloths or towels to use with the device. This refillable holder may be designed to merely hold a stack of disposable cloths or may be designed to manually or automatically dispense cloths or towels in a similar fashion to a paper towel holder, a public bathroom towel holder or an automatic dispenser having a push button or sensor that when activated dispenses towels or cloths.

Contemplated devices may also be utilized with additional liquids or substances, including baby oil, natural oil, aromatic or essential oils, skin cleanser, lotion, pharmaceutical preparations or a combination thereof. These additional liquids or substances may be utilized in the primary reservoir or may be utilized in at least one additional reservoir or smaller independent reservoir.

Contemplated devices do not need to be reserved for use in homes with children and babies, but can be used to clean up after pets and adults. In addition, contemplated devices can be used in kennels, hospitals and nursing homes. Also, these devices are designed to be portable, so they can be moved around indoors and also can be taken on trips and to other locations. The battery operation feature would be especially useful for traveling, since outlets are not available in cars, boats or RVs.

Thus, specific embodiments and applications of versatile bath and cleansing water dispensers and their methods of production have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

I claim:

1. A bathing and cleansing device, comprising:
a heating mechanism;
a liquid reservoir coupled to the heating mechanism, and
a dispensing mechanism coupled to the liquid reservoir.

2. The bathing device of claim 1, comprising at least one additional liquid reservoir.

3. The bathing device of claim 2, wherein the at least one additional liquid reservoir may hold baby oil, natural oil, aromatic oils, skin cleanser, lotion, pharmaceutical preparations or a combination thereof.

4. The bathing device of claim 1, wherein the liquid reservoir is designed to hold and store a liquid.

5. The bathing device of claim 1, wherein the heating mechanism comprises a heating element.

6. The bathing device of claim 1, further comprising a power element.

7. The bathing device of claim 6, wherein the power element comprises electric power, battery power, solar power or a combination thereof.

8. The bathing device of claim 1, further comprising at least one control device.

9. The bathing device of claim 8, wherein the at least one control device comprises at least one touch pad, at least one switch, at least one knob or a combination thereof.

10. The bathing device of claim 1, further comprising an independent heating element.

11. The bathing device of claim 10, wherein the independent heating element comprises a heated contact area for receiving a dish, plate or cloth receptacle.

12. The bathing device of claim 1, further comprising a locking mechanism.

13. The bathing device of claim 12, wherein the locking mechanism is coupled to the heating element, the dispenser or a combination thereof.

14. The bathing device of claim 1, wherein the heating mechanism heats a liquid to a predetermined temperature.

15 The bathing device of claim 14, wherein the predetermined temperature comprises a temperature less than the boiling temperature of the liquid.

16. The bathing device of claim 14, wherein the predetermined temperature comprises a temperature that is at least 10 percent lower than the boiling temperature of the liquid.

17. The bathing device of claim 14, wherein the predetermined temperature comprises a temperature that is at least 25 percent lower than the boiling temperature of the liquid.

18. The bathing device of claim 14, wherein the predetermined temperature is a sanitizing temperature.

19. The bathing device of claim 1, wherein the cleansing device further comprises an integrated spill tray.
